(19) United States
(12) Patent Application Publication
(10) Pub. No.: US 2026/0338221 A1
(43) Pub. Date: Oct. 29, 2026

(54) SELF-LOCKING CARABINERS

(71) Applicant: FAIRYLAND (SHANGHAI) NEW MATERIAL TECHNOLOGY CO., LTD., Shanghai (CN)

(72) Inventors: Jing XU, Shanghai (CN); Baiwen HU, Shanghai (CN)

(73) Assignee: FAIRYLAND (SHANGHAI) NEW MATERIAL TECHNOLOGY CO., LTD., Shanghai (CN)

(21) Appl. No.: 19/388,968

(22) Filed: Nov. 13, 2025

(30) Foreign Application Priority Data
Apr. 25, 2025 (CN) 202510533014.8
Apr. 25, 2025 (CN) 202510533015.2
Jul. 7, 2025 (WO) PCT/CN2025/107289
Jul. 7, 2025 (WO) PCT/CN2025/107290

(51) Int. Cl. F16B 45/02

(52) U.S. Cl. CPC F16B 45/028; F16B 45/026

(57) ABSTRACT

Provided is a self-locking carabiner, including: a carabiner body, a locking arm, and a carabiner ring. The carabiner ring is disposed at one end of the carabiner body, a hook-shaped arm is disposed at the other end of the carabiner body, a rope passing opening is formed between an end of the hook-shaped arm away from the carabiner body and the carabiner body, an end of the locking arm close to the carabiner body is rotatably connected to the carabiner body, and an end of the locking arm away from the carabiner body is latched to an end of the hook-shaped arm close to the carabiner body; and an unlocking structure is disposed on the hook-shaped arm and is movably connected to the hook-shaped arm, and the locking arm includes a locked state and an unlocked state, which are controlled by the unlocking structure.

### CROSS-REFERENCE TO RELATED APPLICATIONS

The present application claims priority to International Application No. PCT/CN2025/107289 filed on Jul. 7, 2025 and International Application No. PCT/CN2025/107290 filed on Jul. 7, 2025, the International Application No. PCT/CN2025/107289 claims priority to Chinese Patent Application No. 202510533014.8 filed on Apr. 25, 2025, and the International Application No. PCT/CN2025/107290 claims priority to Chinese Patent Application No. 202510533015.2 filed on Apr. 25, 2025, the entire contents of each of which are hereby incorporated by reference.

### TECHNICAL FIELD

The present disclosure relates to a technical field of safety fasteners, and in particular to a self-locking carabiner.

### BACKGROUND

In daily life and industrial applications, carabiners, as common connection devices, are widely used in backpacks, mountaineering equipment, safety ropes, and other fields. However, traditional carabiners may have problems such as accidental unlocking or insufficient stability during use, especially in high-intensity or complex environments, where such safety hazards are particularly prominent.

Therefore, it is desired to provide a self-locking carabiner, which enhances stability and safety of the carabiner through an innovative structural design, ensuring its reliable operation in various usage scenarios.

### SUMMARY

One or more embodiments of the present disclosure provide a self-locking carabiner, comprising: a carabiner body, a locking arm, and a carabiner ring, wherein the carabiner ring is disposed at one end of the carabiner body, a hook-shaped arm is disposed at the other end of the carabiner body, a rope passing opening is formed between an end of the hook-shaped arm away from the carabiner body and the carabiner body, an end of the locking arm close to the carabiner body is rotatably connected to the carabiner body, and an end of the locking arm away from the carabiner body is latched to an end of the hook-shaped arm close to the carabiner body; and an unlocking structure is disposed on the hook-shaped arm, the unlocking structure is movably connected to the hook-shaped arm, the locking arm includes a locked state and an unlocked state, and the locked state and the unlocked state are controlled by the unlocking structure.

In some embodiments, the unlocking structure includes an unlocking button, a through hole is disposed on the hook-shaped arm, the unlocking button is movably engaged in the through hole, the unlocking button includes a button portion and a pushing portion, the button portion and the pushing portion are respectively located on opposite sides of the unlocking button, and a sliding surface is disposed on the pushing portion; a protrusion is disposed on an inner side wall surface of the hook-shaped arm, and one end of a self-locking torsion spring is disposed on the locking arm, when the locking arm is in the locked state, the other end of the self-locking torsion spring abuts against the protrusion to prevent the locking arm from rotating; and when the sliding surface is pushed into the through hole of the hook-shaped arm, an end of the sliding surface away from the carabiner body protrudes from the through hole by applying a pressing force to an end of the button portion away from the carabiner body, to lift an end of the self-locking torsion spring that abuts against the protrusion to separate from the protrusion, and the locking arm switches from the locked state to the unlocked state.

In some embodiments, the unlocking structure includes an unlocking member, a limiting rod, and a return spring; the unlocking member is disposed outside the hook-shaped arm, the unlocking member is rotatably connected to the hook-shaped arm via a second rotating shaft, the limiting rod and the return spring are disposed in the carabiner body, and the limiting rod is rotatably connected to the carabiner body; and a locking tongue portion and an abutting portion are respectively disposed at two ends of the limiting rod, when the locking arm is in the locked state, the locking tongue portion at least partially protrudes from an inner side wall surface of the hook-shaped arm, the abutting portion abuts against the unlocking member, one end of a self-locking torsion spring is disposed on the locking arm, and the other end of the self-locking torsion spring abuts against the locking tongue portion to prevent the locking arm from rotating.

In some embodiments, the unlocking structure includes a movable button and a pushing part, wherein the movable button is arranged on an outer side wall surface of the hook-shaped arm, a through hole is provided on the hook-shaped arm, the pushing part is slidably clamped in the through hole, and a pushing surface is provided on the pushing part; a protrusion is disposed on an inner side wall surface of the hook-shaped arm, and one end of a self-locking torsion spring is disposed on the locking arm; when the locking arm is in the locked state, the other end of the self-locking torsion spring abuts against the protrusion to prevent the locking arm from rotating; and the pushing surface protrudes out of the through hole by applying a pressing force to the movable button, to lift an end of the self-locking torsion spring that abuts against the protrusion to separate from the protrusion, and the locking arm switches from the locked state to the unlocked state.

### BRIEF DESCRIPTION OF THE DRAWINGS

The present disclosure is further illustrated by way of exemplary embodiments. These exemplary embodiments are described in detail with reference to the accompanying drawings. These embodiments are not limiting. In these embodiments, the same reference numerals denote the same structures, wherein:

FIG. 1 is a schematic diagram illustrating a three-dimensional structure of a self-locking carabiner with a locking arm in a locked state according to some embodiments of the present disclosure;

FIG. 2 is a schematic diagram illustrating a three-dimensional structure of a self-locking carabiner with a locking arm in an unlocked state according to some embodiments of the present disclosure;

FIG. 3 is a schematic diagram illustrating another three-dimensional structure of the self-locking carabiner with the locking arm in the locked state according to some embodiments of the present disclosure;

FIG. 4 is a schematic diagram illustrating a cross-sectional view of the self-locking carabiner shown in FIG. 3;

FIG. 5 is a schematic diagram illustrating a cross-sectional view of the self-locking carabiner shown in FIG. 2;

FIG. 6 is a schematic diagram illustrating a three-dimensional structure of an unlocking button of the self-locking carabiner according to some embodiments of the present disclosure;

FIG. 7 is a schematic diagram illustrating an installation position of a locking block of the self-locking carabiner according to some embodiments of the present disclosure;

FIG. 8 is a schematic diagram illustrating another three-dimensional structure of the self-locking carabiner with the locking arm in a locked state according to some embodiments of the present disclosure;

FIG. 9 is a schematic diagram illustrating another three-dimensional structure of the self-locking carabiner with a locking arm in the unlocked state according to some embodiments of the present disclosure;

FIG. 10 is a schematic diagram illustrating a cross-sectional view of the self-locking carabiner shown in FIG. 8;

FIG. 11 is a schematic diagram illustrating a cross-sectional view of the self-locking carabiner shown in FIG. 9;

FIG. 12 is a schematic diagram illustrating another cross-sectional view of the self-locking carabiner shown in FIG. 8;

FIG. 13 is a schematic diagram illustrating another cross-sectional view of the self-locking carabiner shown in FIG. 9;

FIG. 14 is a schematic diagram illustrating another installation position of the locking block of the self-locking carabiner according to some embodiments of the present disclosure;

FIG. 15 is a schematic diagram illustrating a three-dimensional structure of the self-locking carabiner according to some embodiments of the present disclosure;

FIG. 16 is a schematic diagram illustrating a three-dimensional structure of a movable button and a pushing part according to some embodiments of the present disclosure;

FIG. 17 is a schematic diagram illustrating an enlarged structure of a hook-shaped arm at a through hole according to some embodiments of the present disclosure.

Description of reference numerals: 1, carabiner body; 2, locking arm; 21, guide groove; 22, limiting portion; 3, carabiner ring; 4, hook-shaped arm; 41, through hole; 42, protrusion; 43, arc-shaped inclined surface; 44, arc segment; 45, guide fitting portion; 5, unlocking button; 51, button portion; 52, elastic portion; 53, engaging portion; 54, pushing portion; 55, sliding surface; 56, groove; 57, first boss; 58, second boss; 59, inner convex arc segment; 6, second rotating shaft; 70, unlocking member; 7, limiting rod; 71, locking tongue portion; 72, abutting portion; 73, rotating portion; 74, inclined segment; 75, first arc segment; 76, second arc segment; 8, return spring; 9, self-locking torsion spring; 91, straight segment; 10, third rotating shaft; 11, first rotating shaft; 12, locking block; A, rope passing opening; B, rope receiving hole.

### DETAILED DESCRIPTION

To more clearly illustrate the technical solutions of the embodiments of the present disclosure, the drawings used in the description of the embodiments are briefly introduced below. Obviously, the drawings in the following description are merely some examples or embodiments of the present disclosure. For those of ordinary skill in the art, without creative effort, the present disclosure can be applied to other similar scenarios based on these drawings. Unless obviously obtained from the context or the context illustrates otherwise, the same numeral in the drawings refers to the same structure or operation.

It should be understood that the terms “system”, “device”, “unit”, and/or “module” used herein are methods for distinguishing components, elements, parts, sections, or assemblies of different levels. However, if other words can achieve the same purpose, the words can be replaced by other expressions.

As shown in the present disclosure, unless the context clearly indicates an exception, words such as “a”, “an”, “one”, and/or “the” are not limited to the singular form and may also include the plural form. Generally, the terms “include” and “comprise” only indicate the inclusion of explicitly identified steps and elements. These steps and elements do not constitute an exclusive list. The method or device may also include other steps or elements.

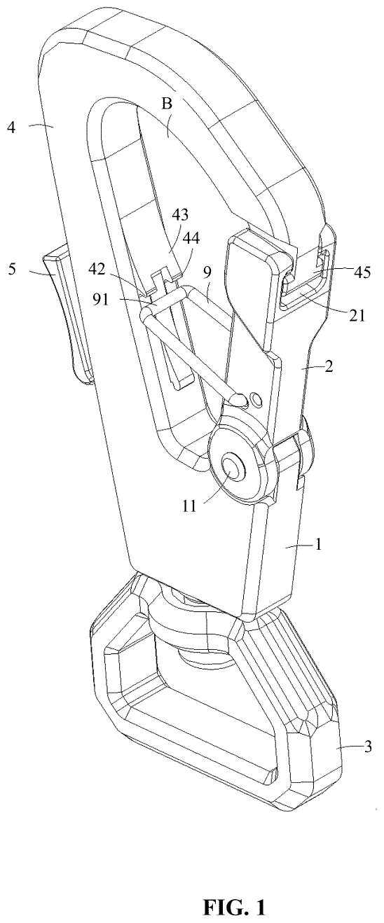

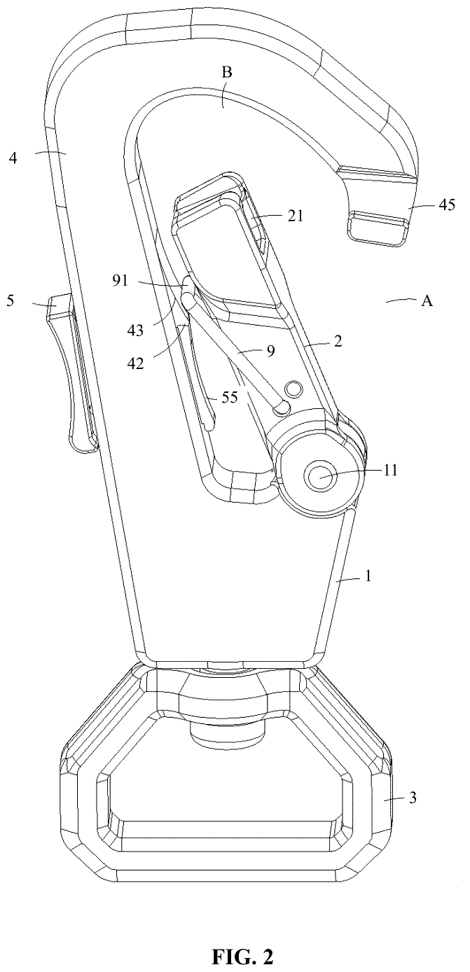

Some embodiments of the present disclosure provide a self-locking carabiner. FIG. 1 is a schematic diagram illustrating a three-dimensional structure of a self-locking carabiner with a locking arm in a locked state according to some embodiments of the present disclosure. FIG. 2 is a schematic diagram illustrating a three-dimensional structure of a self-locking carabiner with a locking arm in an unlocked state according to some embodiments of the present disclosure.

In some embodiments, as shown in FIG. 1 to FIG. 2, the self-locking carabiner includes a carabiner body 1, a locking arm 2, and a carabiner ring 3. The carabiner ring 3 is disposed at one end of the carabiner body 1, a hook-shaped arm 4 is disposed at the other end of the carabiner body 1, and a rope passing opening A is formed between an end of the hook-shaped arm 4 away from the carabiner body 1 and the carabiner body 1. An end of the locking arm 2 close to the carabiner body 1 is rotatably connected to the carabiner body 1, and an end of the locking arm 2 away from the carabiner body 1 is latched at an end of the hook-shaped arm 4 close to the carabiner body 1. An unlocking structure is disposed on the hook-shaped arm 4, the unlocking structure is movably connected to the hook-shaped arm 4, the locking arm 2 includes a locked state and an unlocked state, and the locked state and the unlocked state are controlled by the unlocking structure.

The carabiner body 1 refers to a main body portion of the self-locking carabiner, configured to connect and support other components of the self-locking carabiner (e.g., the locking arm 2 and the carabiner ring 3). In some embodiments, one end (also referred to as a first end) of the carabiner body 1 and the carabiner ring 3 may be connected by means of hinging, welding, riveting, bolt fastening, etc. In some embodiments, the other end (also referred to as a second end) of the carabiner body 1 and the hook-shaped arm 4 are integrally formed. The first end and the second end are disposed opposite to each other.

The locking arm 2 refers to a rotatable arm-shaped structure on the self-locking carabiner, configured to enable the self-locking carabiner to achieve engagement. The locking arm 2 includes a fixed end and a movable end. The fixed end refers to an end of the locking arm 2 close to the carabiner body 1. The movable end refers to an end of the locking arm 2 close to the hook-shaped arm. In some embodiments, the fixed end of the locking arm 2 is rotatably connected to the carabiner body 1. The movable end performs circular motion with the fixed end as the center. The rotatable connection may be achieved by means of a bearing, a rotating shaft, a hinge, etc.

The carabiner ring 3 refers to an interface portion of the self-locking carabiner, configured to connect the self-locking carabiner to an external object (e.g., an equipment attachment point, a rope, a strap, etc.). In some embodiments, the carabiner ring 3 may be fixedly mounted at one end of the carabiner body 1. In some embodiments, the carabiner ring 3 may be detachably mounted at one end of the carabiner body 1. The present disclosure does not impose special limitations on fixed mounting and detachable mounting, and operations well-known to those skilled in the art may be adopted. In some embodiments, the carabiner ring 3 may be a regular ring structure such as a D-shape, a circle, a square, etc. In some embodiments, the c 3 may also be other irregular ring structures.

The hook-shaped arm 4 refers to a hook-shaped structural member configured to hook the external object. In some embodiments, the hook-shaped arm 4 may be divided into a fixed segment and a hook segment. In some embodiments, the fixed segment of the hook-shaped arm 4 is connected to the carabiner body by mechanical means (e.g., a hinge, a pin shaft, or direct fixation, etc.). The hook segment of the hook-shaped arm 4 is an open end. In some embodiments, the movable end of the locking arm 2 may be latched to the open end of the hook-shaped arm 4. The movable end of the locking arm 2 and the open end of the hook-shaped arm 4 may be connected by a buckle structure, or the like.

The locked state refers to a state where the movable end of the locking arm 2 is connected to the open end of the hook-shaped arm 4 to keep the self-locking carabiner engaged (as shown in FIG. 1). In some embodiments, in the locked state, the locking arm 2 and the hook-shaped arm 4 form an engagement state, thereby ensuring the stability and the safety of the self-locking carabiner and preventing accidental opening.

The unlocked state refers to a state where the movable end of the locking arm 2 is separated from the open end of the hook-shaped arm 4 to open the self-locking carabiner for the external object to passage (as shown in FIG. 2). In some embodiments, in the unlocked state, the engagement state between the locking arm 2 and the hook-shaped arm 4 is released, allowing a user to open the self-locking carabiner or adjust the external object.

The unlocking structure is configured to control the state of the locking arm 2 and enable the self-locking carabiner to achieve a self-locking function. In some embodiments, the unlocking structure may be a sliding member or a button with a buckle. A groove or a protrusion is disposed on the hook-shaped arm 4. After the locking arm 2 is locked, the buckle automatically snaps into the groove or the protrusion of the hook-shaped arm 4, ensuring that the locking arm 2 is stably fixed.

The rope passing opening A refers to an opening on the self-locking carabiner through which the external object can pass. In some embodiments, as shown in FIG. 2, when the rope passing opening A is in an open state, the external object may pass through the rope passing opening A.

In some embodiments, as shown in FIG. 1 to FIG. 2, the locking arm 2 and an inner side wall surface of the hook-shaped arm 4 form a rope receiving hole B. The rope passing opening A is connected to the rope receiving hole B. When the rope passing opening A is in the open state, the external object (e.g., the rope) enters and exits the rope receiving hole B through the rope passing opening A. The rope is connected to the hook-shaped arm 4. Another rope is disposed in the carabiner ring 3, and the two ropes are connected to each other by the self-locking carabiner.

The unlocking structure is disposed on the hook-shaped arm 4, and the unlocking structure is movably connected to the hook-shaped arm 4. In some embodiments, in a natural state, the movable end of the locking arm 2 is engaged with the open end of the hook-shaped arm 4, the locking arm 2 is in the locked state, and the rope passing opening A is in a closed state. The locking arm 2 is controlled by the unlocking structure to separate the movable end of the locking arm 2 from the open end of the hook-shaped arm 4, switching to the unlocked state, and the rope passing opening A is in the open state. In some embodiments, when an external force presses the movable end of the locking arm 2, the movable end of the locking arm 2 may rotate toward the open end of the hook-shaped arm 4, thereby contacting and engaging with the open end of the hook-shaped arm 4 to form the locked state, and the rope passing opening A is in the closed state. In some embodiments, after the external force presses the unlocking button 5, the movable end of the locking arm 2 may rotate toward an inner side of the hook-shaped arm 4 (a side away from the rope passing opening A), thereby causing the movable end of the locking arm 2 to disengage from the open end of the hook-shaped arm 4, switching again to the unlocked state.

In some embodiments, as shown in FIG. 2, the self-locking carabiner further includes a first rotating shaft 11 disposed on the carabiner body 1, and an end of the locking arm 2 close to the carabiner body 1 is rotatably connected to the carabiner body 1 via the first rotating shaft 11.

The first rotating shaft 11 refers to a rotational connection component disposed on the carabiner body 1.

In some embodiments, rotation of the first rotating shaft 11 may drive a movable end of the locking arm 2 to rotate towards the open end of the hook-shaped arm 4, thereby connecting and engaging the movable end of the locking arm 2 with the open end of the hook-shaped arm 4. In some embodiments, rotation of the first rotating shaft 11 may drive the movable end of the locking arm 2 to rotate away from the open end of the hook-shaped arm 4, thereby disengaging the movable end of the locking arm 2 from the open end of the hook-shaped arm 4.

In some embodiments of the present disclosure, the first rotating shaft 11 is disposed on the carabiner body 1, so that a stable rotational pivot is provided for the locking arm 2, thereby ensuring that the locking arm 2 does not shift or wobble during rotation, and enabling the locking arm 2 to rotate flexibly around the carabiner body, facilitating locking and unlocking operations by a user and improving the user experience.

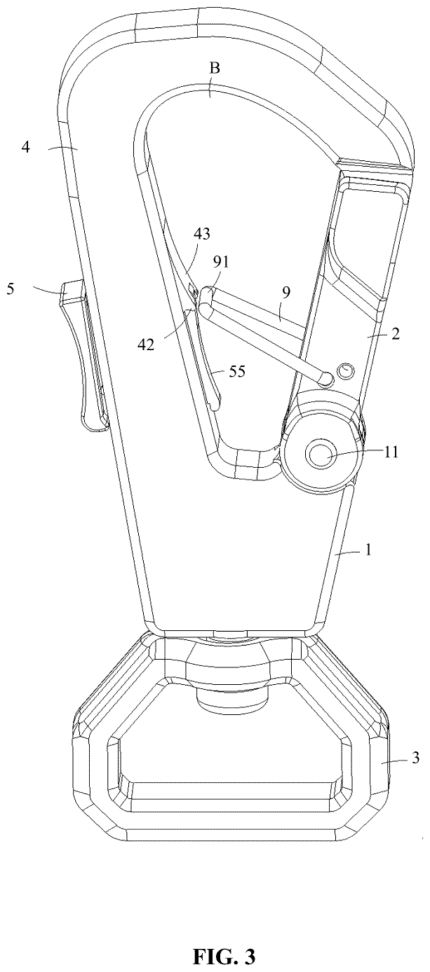

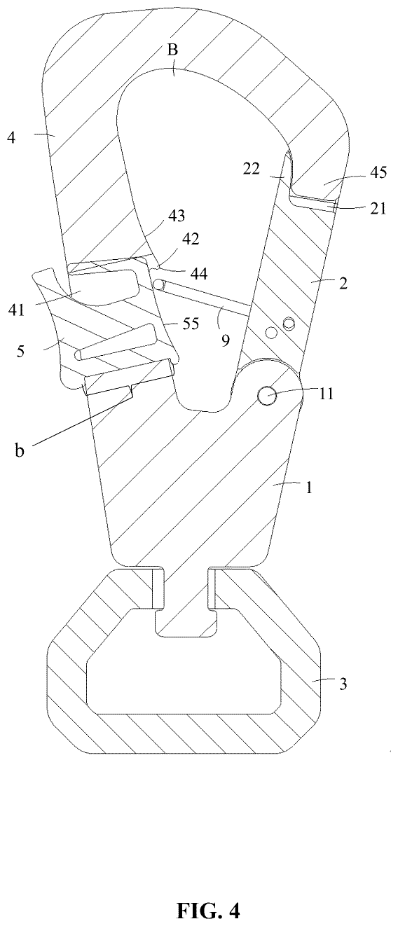

FIG. 3 is a schematic diagram illustrating another three-dimensional structure of the self-locking carabiner with the locking arm in the locked state according to some embodiments of the present disclosure. FIG. 4 is a schematic diagram illustrating a cross-sectional view of the self-locking carabiner shown in FIG. 3.

In some embodiments, as shown in FIG. 1 to FIG. 4, a guide groove 21 and a limiting portion 22 are respectively disposed at the end (i.e., the movable end) of the locking arm 2 away from the carabiner body 1, a guide fitting portion 45 is disposed at an end (i.e., the open end) of the hook-shaped arm 4 close to the carabiner body 1, the guide groove 21 and the guide fitting portion 45 are matched, and when the locking arm 2 is in the locked state, the guide fitting portion 45 is located in the guide groove 21 and is blocked by the limiting portion 22.

The guide groove 21 is configured to guide a movement trajectory of the guide fitting portion 45. In some embodiments, the guide groove 21 may be a regular groove structure or an irregular groove structure. For example, the guide groove 21 may be a T-shaped groove.

The limiting portion 22 refers to a blocking structure disposed on the locking arm 2, configured to restrict movement of the locking arm 2. The limiting portion 22 is disposed at the end (i.e., the movable end) of the locking arm 2 away from the carabiner body 1. When the locking arm 2 is in the locked state, the limiting portion 22 blocks movement of the guide fitting portion 45 along the guide groove 21, thereby restricting the locking arm 2 from moving further away from the hook-shaped arm 4, thus preventing accidental disengagement of the locking arm 2 from the hook-shaped arm 4.

The guide fitting portion 45 is configured to guide a movement trajectory of the locking arm 2, ensuring smooth and precise operation of the self-locking carabiner during a locking process and an unlocking process. In some embodiments, a shape of the guide fitting portion 45 matches a shape of the guide groove 21. For example, as shown in FIG. 1, when the guide groove 21 is the T-shaped groove, the guide fitting portion 45 is a T-shaped structure.

In some embodiments of the present disclosure, the guide groove 21 and the guide fitting portion 45 are matched to improve the stability and the accuracy of engagement between the locking arm 2 and the hook-shaped arm 4. The limiting portion 22 blocks the guide fitting portion 45 when the locking arm 2 is in the locked state, thereby preventing excessive movement or deviation of the locking arm 2 from a correct position.

In some embodiments, the rope passing opening A is formed between the hook-shaped arm 4 and the carabiner body 1 for the external object to pass through, and an end (i.e., the fixed end) of the locking arm 2 close to the carabiner body 1 is rotatably connected to the carabiner body 1 via the first rotating shaft 11 on the carabiner body 1, enabling the locking arm 2 to rotate around the rotating shaft. When the locking arm 2 is in the locked state, as shown in FIG. 1, the guide groove 21 at the end of the locking arm 2 away from the carabiner body 1 matches the guide fitting portion at the end of the hook-shaped arm 4 close to the carabiner body 1, and the guide fitting portion enters the guide groove 21 and is blocked by the limiting portion 22 on the locking arm 2, thereby stably latching the end of the locking arm 2 away from the carabiner body 1 (i.e., the movable end) to the hook-shaped arm 4, closing the rope passing opening A to prevent the external object from falling off. When an unlocking structure on the hook-shaped arm 4 is operated, as shown in FIG. 2, the locking arm 2 may be driven to rotate around the first rotating shaft, so that the guide fitting portion disengages from the guide groove 21 and the blocking by the limiting portion 22, the locking arm 2 switches to the unlocked state, and the rope passing opening A is opened to allow the external object to be inserted or removed. Controllable switching between the locked state and the unlocked state is achieved through the cooperation of the structures above.

Some embodiments of the present disclosure may include, but are not limited to, the following beneficial effects. (1) The locking arm is latched to the hook-shaped arm, so that the carabiner ring is securely fixed in the locked state, preventing accidental loosening and significantly improving reliability and safety of the carabiner. The unlocking structure disposed on the hook-shaped arm can precisely control the state of the locking arm, avoiding unintended unlocking caused by misoperation and further enhancing safety. (2) The design of the unlocking structure enables the locking arm to quickly switch between the locked state and the unlocked state, thereby facilitating quick installation or disassembly of the carabiner by a user. The design of the rope passing opening allows a rope to pass through and be secured smoothly, thereby simplifying the usage process and improving operational convenience.

It should be noted that the above description of the self-locking carabiner is merely for convenience of description and cannot limit the present disclosure to the scope of the illustrated embodiments. It can be understood that for those skilled in the art, after understanding the principle of the structure, various components may be combined arbitrarily, or sub-components may be formed and connected with other components, without departing from this principle.

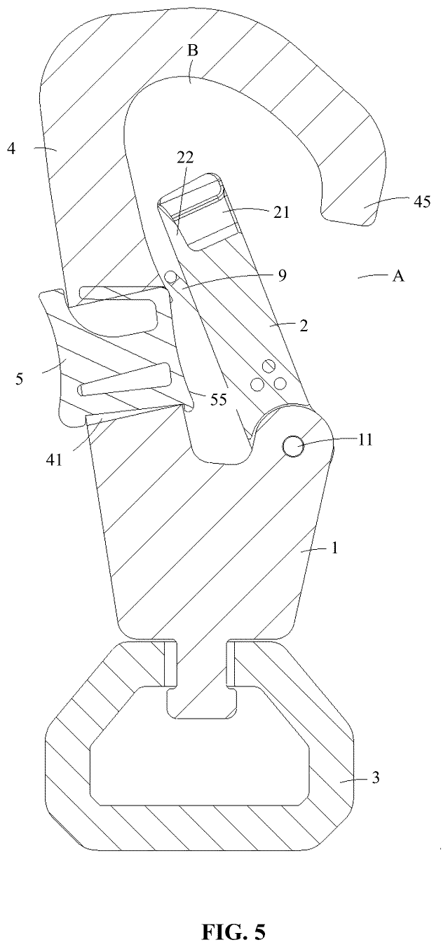

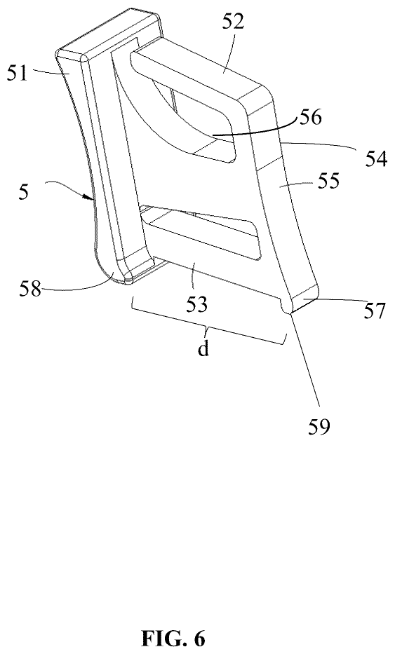

FIG. 5 is a schematic diagram illustrating a cross-sectional view of the self-locking carabiner shown in FIG. 2. FIG. 6 is a schematic diagram illustrating a three-dimensional structure of an unlocking button of the self-locking carabiner according to some embodiments of the present disclosure.

In some embodiments, as shown in FIG. 1 to FIG. 6, the unlocking structure includes an unlocking button 5, a through hole 41 is disposed on the hook-shaped arm 4, and the unlocking button 5 is movably engaged in the through hole 41. The unlocking button 5 includes a button portion 51 and a pushing portion 54, the button portion 51 and the pushing portion 54 are respectively located on opposite sides of the unlocking button 5, and a sliding surface 55 is disposed on the pushing portion 54. A protrusion 42 is disposed on an inner side wall surface of the hook-shaped arm 4, and one end (a fixed end) of a self-locking torsion spring 9 is disposed on the locking arm 2. In some embodiments, when the locking arm 2 is in the locked state, the other end (a movable end) of the self-locking torsion spring 9 abuts against the protrusion 42 to prevent the locking arm from rotating. In some embodiments, when the sliding surface 55 is pushed into the through hole 41 of the hook-shaped arm 4, an end of the sliding surface 55 away from the carabiner body 1 protrudes from the through hole 41 by applying a pressing force to an end of the button portion 51 away from the carabiner body 1, to lift an end (the movable end) of the self-locking torsion spring 9 that abuts against the protrusion 42 to separate from the protrusion 42, and the locking arm 2 switches from the locked state to the unlocked state.

The unlocking button 5 refers to a button structure configured to realize state switching of the self-locking carabiner. The button portion 51 refers to a part of the unlocking button 5 configured to receive the external pressing force. The user may apply a pressing force to the button portion 51. The button portion 51 is located on an outer side of the unlocking button 5 (i.e., a side away from the locking arm 2). The pushing portion 54 refers to a part of the unlocking button 5 configured to transmit the pressing force and push the locking arm to rotate. The pushing portion 54 is located on an inner side of the unlocking button 5 (i.e., a side close to the locking arm 2). The button portion 51 and the pushing portion 54 may be connected in various ways. For example, the button portion 51 and the pushing portion 54 are integrally formed. As another example, the button portion 51 and the pushing portion 54 are detachably connected via a snap-fit, a screw, etc.

The sliding surface 55 refers to an inclined surface or a curved surface on the pushing portion 54. In some embodiments, as shown in FIG. 2 to FIG. 6, the sliding surface 55 refers to a wall surface of the pushing portion 54 close to an inner side of the hook-shaped arm 4. In the locked state, the self-locking torsion spring 9 contacts the sliding surface 55 and abuts against the protrusion 42. When switching from the unlocked state to the locked state, the sliding surface 55 displaces towards the inner side of the hook-shaped arm 4 by applying the pressing force to the button portion 51, and the self-locking torsion spring 9 no longer abuts against the protrusion 42. At this time, the locking arm 2 rotates towards the inner side wall surface of the hook-shaped arm 4 by applying an external force to the locking arm 2, and the self-locking torsion spring 9 may move along the sliding surface 55 to pass over the protrusion 42 and slide along the inner side wall surface of the hook-shaped arm 4.

The through hole 41 refers to an opening in the hook-shaped arm 4 for accommodating the unlocking button 5. A size and a shape of the through hole match a size and a shape of the pushing portion 54 of the unlocking button 5. In some embodiments, the through hole 41 is disposed on the fixed segment of the hook-shaped arm 4. In some embodiments, an axial direction of the through hole 41 refers to a direction from the outer side wall surface to the inner side wall surface of the hook-shaped arm 4.

The protrusion 42 of the hook-shaped arm 4 refers to a protruding structure located on the inner side wall surface of the hook-shaped arm 4 close to the through hole 41. The protrusion 42 may limit a movement range of the self-locking torsion spring 9 and maintain the locked state of the locking arm 2, thereby achieving the self-locking function of the self-locking carabiner.

The self-locking torsion spring 9 is configured to control a state of the locking arm 2. The self-locking torsion spring 9 may be a spring with an elastic torsional force, capable of undergoing torsional deformation under the external force. In some embodiments, the self-locking torsion spring 9 may be made of a metal material, or the like. One end (the fixed end) of the self-locking torsion spring 9 is fixedly connected to the locking arm 2 by a screw, welding, bonding, or the like. In the locked state, another end (the movable end) of the self-locking torsion spring 9 may slide along the sliding surface 55 below the protrusion 42. In the unlocked state, the movable end of the self-locking torsion spring 9 may disengage from the protrusion 42 and slide along the inner side wall surface of the hook-shaped arm 4.

In some embodiments, as shown in FIG. 1 and FIG. 4, when the locking arm 2 is in the locked state, an end of the sliding surface 55 close to the protrusion 42 is pushed into the through hole 41. When the self-locking torsion spring 9 moves along the sliding surface 55 in a direction away from the carabiner body 1, the other end of the self-locking torsion spring 9 abuts against a stopping position of the protrusion 42, thereby preventing the locking arm 2 from rotating. The stopping position of the protrusion 42 refers to a position of the protrusion 42 on a side close to the sliding surface 55.

In some embodiments, as shown in FIG. 3, an upper portion (i.e., an end away from the carabiner body 1) of the button portion 51 rotates under the pressing force, causing an upper portion (i.e., an end away from the carabiner body 1) of the sliding surface 55 to protrude from the through hole 41, thereby lifting the movable end of the self-locking torsion spring 9 to disengage from the stopping position of the protrusion 42. As shown in FIG. 2 and FIG. 5, when the button portion 51 is pressed, the locking arm 2 rotates toward the fixed segment of the hook-shaped arm 4 under the external force, driving the movable end of the self-locking torsion spring 9 to cross over the protrusion 42 from the sliding surface 55 and move toward the open end of the hook-shaped arm 4 along the inner side wall surface of the hook-shaped arm 4. The self-locking torsion spring 9 undergoes torsional deformation, the rope passing opening A is opened, and the locking arm 2 is in the unlocked state.

In some embodiments, when the external force applied to the locking arm 2 and the pressing force applied to an unlocking button 4 are released, under an elastic restoring force of the self-locking torsion spring 9, the locking arm 2 resets and drives the self-locking torsion spring 9 to move to the stopping position of the protrusion 42, the rope passing opening A is closed, and the locking arm 2 returns to the locked state.

In some embodiments of the present disclosure, the user can easily switch the self-locking carabiner from the locked state to the unlocked state by pressing the button portion of the unlocking button, and the operation is simple and intuitive. In the locked state, one end of the self-locking torsion spring 9 abuts against the protrusion, thereby providing a stable blocking force to prevent accidental rotation of the locking arm and ensuring that the self-locking carabiner is more secure in the locked state.

In some embodiments, as shown in FIG. 6, the unlocking button 5 further includes an elastic portion 52 and an engaging portion 53, the elastic portion 52 is disposed at an end of the unlocking button 5 away from the carabiner body 1, the engaging portion 53 is disposed at an end of the unlocking button 5 close to the carabiner body 1, and the elastic portion 52 is connected to a pushing portion 54.

The elastic portion 52 refers to an elastic part on the unlocking button 5, configured to reset the unlocking button 5 after being pressed. The elastic portion 52 is made of a spring, an elastic sheet, or other elastic materials. The engaging portion 53 is configured to engage the unlocking button 5 with the through hole 41, typically fixed by a snap-fit, a protrusion, or a groove. When the pressing force is applied to the unlocking button 5, the elastic portion 52 is compressed, enabling the pushing portion 54 to move along the axial direction of the through hole 41. When the pressing force is released, the unlocking button 5 resets under the action of the elastic portion 52.

In some embodiments, the elastic portion 52 is disposed on an upper portion (i.e., a side close to the hook-shaped arm 4) of the unlocking button 5, the engaging portion 53 is disposed on a bottom portion (i.e., a side away from the hook-shaped arm 4) of the unlocking button 5. One end of the elastic portion 52 is connected to the pushing portion 54, and another end of the elastic portion 52 extends toward an upper side portion of the unlocking button 5 close to the protrusion 42, abuts against an inner wall of the through hole 41, and is squeezed inside the through hole 41. The engaging portion 53 is snap-fitted at two ends of the through hole 41 along a penetration direction of the through hole 41. The sliding surface 55 is disposed on the pushing portion 54.

In some embodiments of the present disclosure, the elastic portion is disposed on the end of the unlocking button away from the carabiner body, so that automatic resetting after a pressing operation is enabled, thereby ensuring that the unlocking button returns to an initial position and avoiding button jamming or failure. The engaging portion is disposed on the end of the unlocking button close to the carabiner body to form a stable snap-fit between the engaging portion and the hook-shaped arm or other fixed structure, thereby preventing the unlocking button from falling off or becoming loose during use.

In some embodiments, as shown in FIG. 4, an arc-shaped inclined surface 43 is disposed on the protrusion 42, and the arc-shaped inclined surface 43 curves and transitions along the inner side wall surface of the hook-shaped arm 4 in a direction away from the carabiner body 1.

The arc-shaped inclined surface 43 is configured to guide contact or separation between two components (e.g., the self-locking torsion spring 9 and the protrusion 42) to achieve smoother movement or a more stable connection.

In some embodiments, the movable end of the self-locking torsion spring 9 may move back and forth along the arc-shaped inclined surface 43.

In some embodiments of the present disclosure, the arc-shaped inclined surface 43 may smoothly guide the separation of the self-locking torsion spring 9 and the protrusion 42, thereby reducing friction and resistance during the unlocking process and making the unlocking operation smoother.

In some embodiments, as shown in FIG. 4, an arc segment 44 is disposed at a top end of the protrusion 42, and the arc segment 44 is connected to the arc-shaped inclined surface 43.

A shape of the arc segment 44 may be a smooth curve. In some embodiments, a radius and a radian of the arc segment 44 are adjusted according to specific design requirements.

In some embodiments, during a reset process of the locking arm 2, the movable end of the self-locking torsion spring 9 slides along the arc-shaped inclined surface 43 of the hook-shaped arm 4 in a direction away from the open end of the hook-shaped arm 4 until the movable end of the self-locking torsion spring 9 abuts against the stopping position of the protrusion 42.

In some embodiments of the present disclosure, the arc segment is connected to the arc-shaped inclined surface, making contact and separation between the self-locking torsion spring 9 and the protrusion smoother, reducing friction and resistance during movement, and facilitating resetting of the self-locking torsion spring 9 to a bottom of the protrusion 42, thereby facilitating resetting of the locking arm 2.

In some embodiments, as shown in FIG. 3, a straight segment 91 is disposed at an end (the movable end) of the self-locking torsion spring 9 close to the protrusion 42, and when the locking arm 2 is in the locked state, the straight segment 91 abuts against the protrusion 42 to prevent the locking arm 2 from rotating.

The straight segment 91 is configured to prevent rotation of the locking arm in the locked state.

In some embodiments of the present disclosure, direct abutment between the straight segment and the protrusion forms rigid contact, thereby effectively preventing rotation of the locking arm and ensuring that the self-locking carabiner is more stable in the locked state.

In some embodiments, as shown in FIG. 6, the unlocking button further includes a groove 56, a first boss 57, and a second boss 58, and each of the first boss 57 and the second boss 58 includes an inner convex arc segment 59. The groove 56 refers to a gap portion between the elastic portion 52 and the pushing portion 54. The first boss 57 refers to a protruding structure disposed at a bottom of the pushing portion 54. The second boss 58 refers to a protruding structure disposed at a bottom of the button portion 51.

The groove 56 is configured to provide a deformation space for the elastic portion 52.

The first boss 57 and the second boss 58 are configured to facilitate secure snap-fit connection with the carabiner body 1.

In some embodiments, the inner convex arc segment 59 may be made of a flexible material, e.g., elastic rubber, or the like.

In some embodiments, as shown in FIG. 4, a distance (d as shown in FIG. 6) between the inner convex arc segment 59 of the first boss 57 and the inner convex arc segment 59 of the second boss 58 is less than a size of the carabiner body 1 close to the through hole 41, i.e., less than a width (b as shown in FIG. 4) of the through hole 41 along a axial direction of the through hole 41. The axial direction of the through hole refers to a direction in which the through hole 41 penetrates the hook-shaped arm 4, such as a direction from the outer side wall surface to the inner side wall surface of the hook-shaped arm 4.

In some embodiments of the present disclosure, through the dimensional limitation of the inner convex arc segments 59 of the first boss 57 and the second boss 58, when an upper portion of the button portion 51 rotates along the engaging portion 53 under the pressing force, it ensures that the unlocking button 5 does not detach from the through hole 41.

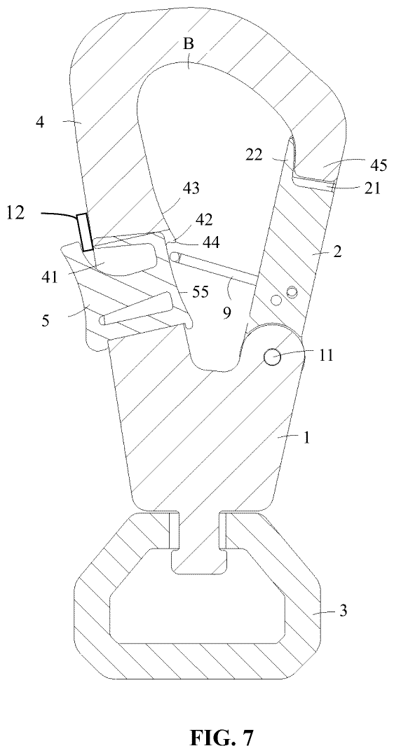

FIG. 7 is a schematic diagram illustrating an installation position of a locking block of the self-locking carabiner according to some embodiments of the present disclosure.

In some embodiments, as shown in FIG. 7, the self-locking carabiner further includes a locking block 12, the locking block is slidably or rotatably disposed on an outer side wall surface of the hook-shaped arm 4, and when the locking arm 2 is in the locked state, the locking block 12 is located between the button portion 51 of the unlocking button 5 and the hook-shaped arm 4.

The locking block 12 is configured to lock the unlocking structure, so that the self-locking carabiner maintains the locked state and prevents accidental unlocking. One end of the locking block 12 is fixed to the carabiner body 1, and the other end of the locking block 12 is slidable or rotatable. In some embodiments, a sliding groove or a guide rail is disposed on the outer side wall surface of the hook-shaped arm 4, and the locking block 12 is embedded in the sliding groove or the guide rail. In some embodiments, a rotating shaft or a rotating pivot is disposed on the outer side wall surface of the hook-shaped arm 4, and the locking block 12 is connected to the hook-shaped arm 4 via the rotating shaft or the rotating pivot, so that the locking block 12 is rotatable around the shaft. The rotating shaft may be a cylindrical shape, a pin, or another structure suitable for rotational motion.

In some embodiments, the locking block 12 may be made of a flexible material, e.g., elastic rubber, etc. In some embodiments, the locking block 12 may have a ramp structure. For example, along a direction from a position closest to the unlocking button 5 to a position away from the unlocking button 5, a size of the locking block 12 increases from small to large, facilitating insertion and removal.

In some embodiments, as shown in FIG. 7, when the locking arm 2 is in the locked state, the locking block 12 is located between an upper end of the button portion 51 away from the carabiner body 1 and the fixed segment of the hook-shaped arm 4 by sliding or rotating the locking block 12, thereby preventing movement of the button portion 51, and ensuring that the locking arm 2 is securely locked to prevent loosening or unlocking caused by the external force or vibration.

In some embodiments of the present disclosure, the locking block 12 is introduced into the self-locking carabiner, so that an additional mechanical block is formed between the button portion 51 of the unlocking button 5 and the hook-shaped arm 4, thereby effectively preventing the unlocking button 5 from being accidentally pressed or triggered by an external force to ensure that the self-locking carabiner is more stable in the locked state.

In some embodiments, as shown in FIG. 1 and FIG. 4, in a normal state, the locking arm 2 and the unlocking button 5 are not subjected to the external force. The movable end (an end away from the carabiner body 1) of the locking arm 2 is latched to the open end (an end close to the carabiner body 1) of the hook-shaped arm 4 under an action of the self-locking torsion spring 9, the straight segment 91 of the self-locking torsion spring 9 abuts against a stopping position of the protrusion 42, and the straight segment 91 cannot move further toward the hook-shaped arm 4. The rope passing opening A is in the closed state, and the locking arm 2 cannot be pressed to rotate toward the fixed segment of the hook-shaped arm 4, the straight segment 91 pushes an upper portion of the sliding surface 55 into the through hole 41 of the hook-shaped arm 4, and the locking arm 2 returns to the locked state.

In some embodiments, as shown in FIG. 3 and FIG. 6, after the unlocking button 5 is pressed, the upper portion of the button portion 51 rotates along the engaging portion 53, so that an end of the sliding surface 55 away from the carabiner body 1 protrudes from the through hole 41, and the movable end of the self-locking torsion spring 9 is lifted and disengaged from the stopping position of the protrusion 42. As shown in FIG. 2 and FIG. 5, the external force is applied to the locking arm 2, and the locking arm 2 rotates toward the inner side wall surface of the hook-shaped arm 4, thereby driving the straight segment 91 of the self-locking torsion spring 9 to cross over the protrusion 42 from the sliding surface 55 and slide along the arc-shaped inclined surface 43 toward the open end of the hook-shaped arm 4. The rope passing opening A is gradually opened, and the locking arm 2 is in the unlocked state.

In some embodiments, after the external force applied to the locking arm 2 and the unlocking button 5 is released, the locking arm 2 resets and drives the straight segment 91 of the self-locking torsion spring 9 to move away from the open end of the hook-shaped arm 4 under the action of the self-locking torsion spring 9, until the straight segment 91 abuts against the stopping position of the protrusion 42. The rope passing opening A is closed, and the locking arm 2 returns to the locked state.

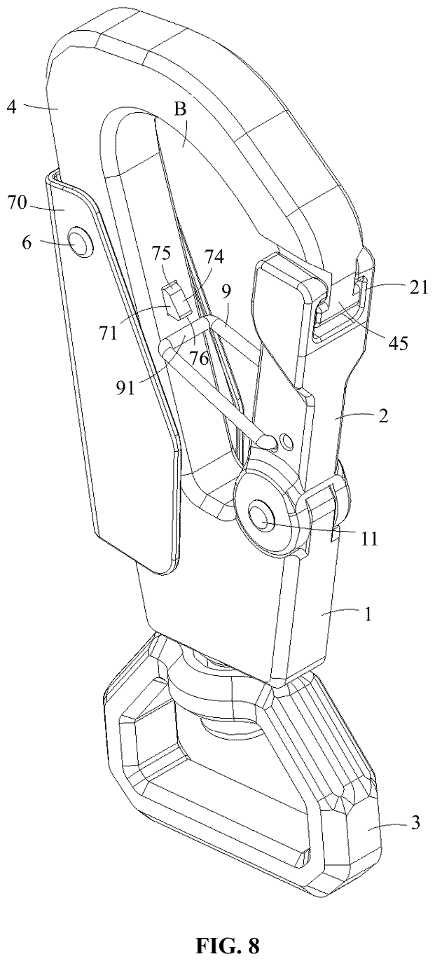

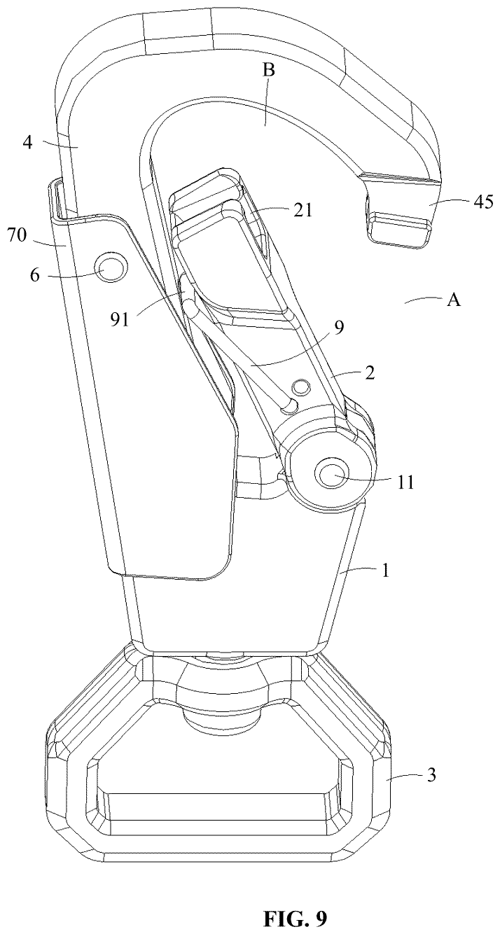

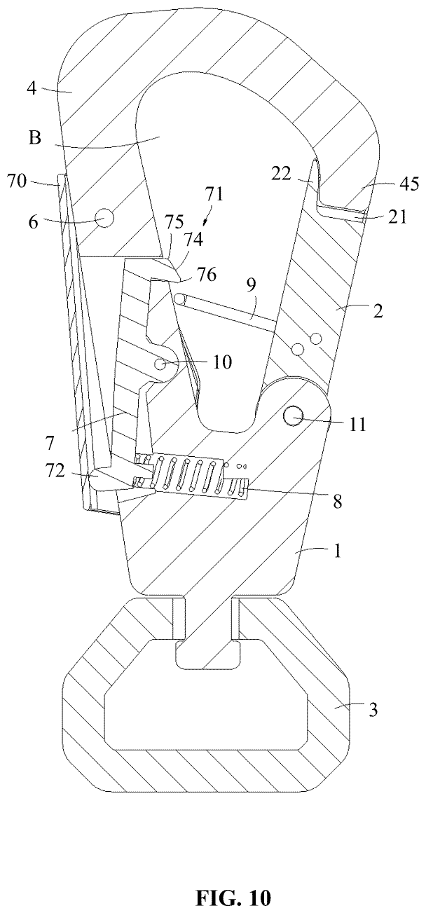

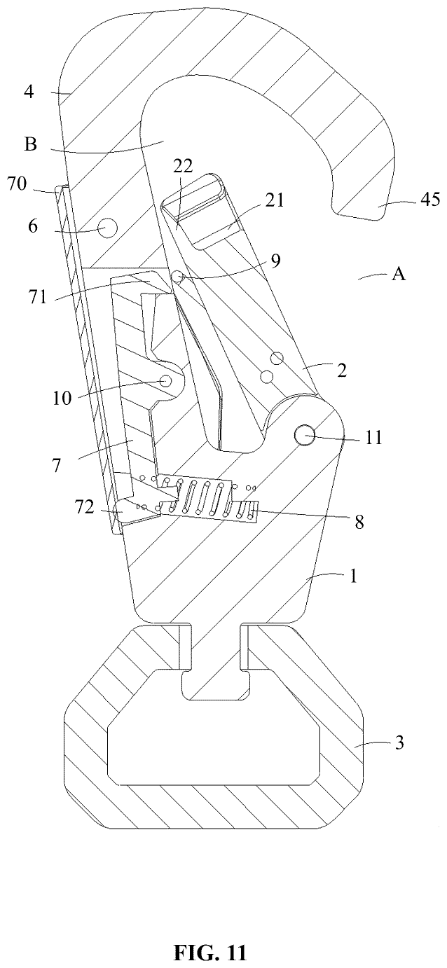

FIG. 8 is a schematic diagram illustrating another three-dimensional structure of the self-locking carabiner with the locking arm in a locked state according to some embodiments of the present disclosure. FIG. 9 is a schematic diagram illustrating another three-dimensional structure of the self-locking carabiner with a locking arm in the unlocked state according to some embodiments of the present disclosure. FIG. 10 is a schematic diagram illustrating a cross-sectional view of the self-locking carabiner shown in FIG. 8. FIG. 11 is a schematic diagram illustrating a cross-sectional view of the self-locking carabiner shown in FIG. 9.

In some embodiments, as shown in FIG. 8 to FIG. 11, the unlocking structure includes an unlocking member 70, a limiting rod 7, and a return spring 8. The unlocking member 70 is disposed outside of the hook-shaped arm 4, the unlocking member 70 is rotatably connected to the hook-shaped arm 4 via a second rotating shaft 6, the limiting rod 7 and the return spring 8 are disposed in the carabiner body 1, and the limiting rod 7 is rotatably connected to the carabiner body 1. A locking tongue portion 71 and an abutting portion 72 are respectively disposed at two ends of the limiting rod 7, when the locking arm 2 is in the locked state, the locking tongue portion 71 at least partially protrudes from an inner side wall surface of the hook-shaped arm 4, the abutting portion 72 abuts against the unlocking member 70, one end (the fixed end) of the self-locking torsion spring 9 is disposed on the locking arm 2, and the other end (the movable end) of the self-locking torsion spring 9 abuts against the locking tongue portion 71 to prevent the locking arm 2 from rotating.

The unlocking member 70 is configured to receive an external pressing force and drive the limiting rod to rotate. In some embodiments, the unlocking member 70 may be a thin plate structure covering the outer side wall surface of the hook-shaped arm 4. One end of the unlocking member 70 close to the carabiner body 1 is fixedly connected to the limiting rod 7, and the other end of the unlocking member 70 away from the carabiner body 1 is rotatably connected to the hook-shaped arm 4. The second rotating shaft 6 refers to a rotating component connecting the unlocking member 70 and the hook-shaped arm 4. For example, the second rotating shaft 6 may be a cylindrical pin shaft, etc. The end of the unlocking member 70 close to the carabiner body 1 may adopt a protrusion or a recess structure to enhance tactile sensation, and the user may apply a pressing force to the end of the unlocking member 70 close to the carabiner body 1.

The limiting rod 7 is configured to control a state of the locking arm 2 through rotation. In some embodiments, the limiting rod may be an elongated rod member. An end of the limiting rod 7 away from the carabiner body 1 is provided with the locking tongue portion 71. The locking tongue portion 71 is configured to prevent the locking arm 2 from rotating, so that the locking arm 2 maintains the locked state. An end of the limiting rod 7 close to the carabiner body 1 is provided with the abutting portion 72. The abutting portion 72 is configured to cooperate with the unlocking member 6 to drive the limiting rod to rotate. The abutting portion 72 at least partially protrudes from an outer side wall surface of the carabiner body 1 and is connected to the unlocking member 70. The locking tongue portion 71 and the abutting portion 72 are integrally formed with the limiting rod 7 or fixedly connected to the limiting rod 7.

The return spring 8 is configured to provide a return force for returning the limiting rod. In some embodiments, the return spring 8 may be a helical spring, etc. The return spring 8 is embedded in the carabiner body 1, the return spring 8 at least partially protrudes from the carabiner body 1 and is connected to the abutting portion 72 of the limiting rod 7.

For more descriptions about the hook-shaped arm 4 and the self-locking torsion spring 9, please refer to FIG. 1 to FIG. 7 and related content.

In some embodiments, the limiting rod 7 rotates by applying the pressing force to a side of the unlocking member 70 close to the carabiner body 1, the abutting portion 72 presses against the return spring 8 so that the return spring 8 is compressed, the locking tongue portion 71 retracts into the hook-shaped arm 4, and the self-locking torsion spring 9 is no longer abutted. As shown in FIG. 9 and FIG. 11, the locking arm is capable of rotating toward the inner side wall surface of the hook-shaped arm 4 by applying an external force to the locking arm 2, the locking arm is in the unlocked state, and the rope passing opening A is opened.

In some embodiments, as shown in FIG. 9, the locking arm 2 and the inner side wall surface of the hook-shaped arm 4 form the rope receiving hole B. The rope passing opening A is connected with the rope receiving hole B. When the rope passing opening A is opened, the rope is capable of entering and exiting the rope receiving hole B through the rope passing opening A, and the rope is connected to the hook-shaped arm 4. Another rope is disposed in the carabiner ring 3, and the two ropes are connected to each other via the self-locking carabiner.

In some embodiments, as shown in FIG. 8 and FIG. 10, the pressing force applied to the unlocking member 70 and the external force applied to the locking arm 2 are released, the limiting rod 7 resets under the action of the return spring 8, and the locking arm 2 resets under the action of the self-locking torsion spring 9. The locking tongue portion 71 protrudes from the inner side wall surface of the hook-shaped arm 4, one end of the self-locking torsion spring 9 abuts against the locking tongue portion 71 to prevent rotation of the locking arm, and the locking arm returns to the locked state.

In some embodiments of the present disclosure, it ensures that the locking arm cannot be accidentally unlocked in the locked state through cooperation of the limiting rod and the self-locking torsion spring 9. The unlocking member is disposed on the outer side wall surface of the hook-shaped arm, and a user is capable of quickly unlocking through a simple operation, e.g., pressing or sliding. The return spring and the self-locking torsion spring 9 ensure that the locking arm is capable of automatically returning to the locked state after unlocking.

In some embodiments, as shown in FIG. 10, a straight segment 91 is disposed at an end of the self-locking torsion spring 9 close to the locking tongue portion 71, and when the locking arm 2 is in the locked state, the straight segment 91 abuts against the locking tongue portion 71 to prevent the locking arm 2 from rotating.

In some embodiments, when the locking arm 2 switches from the locked state to the unlocked state, the straight segment 91 of the self-locking torsion spring 9 slides upward (i.e., in a direction away from the carabiner body 1) along the inner side wall surface of the hook-shaped arm 4 until the rope passing opening A is gradually opened. For more description regarding the straight segment 91, please refer to the related description above.

In some embodiments of the present disclosure, the abutment between the straight segment 91 and the locking tongue portion 71 provides a more direct contact surface to enhance the stability of the locking arm 2 in the locked state.

In some embodiments, as shown in FIG. 11, a third rotating shaft 10 is further disposed on the carabiner body 1, the limiting rod 7 is rotatably connected to the carabiner body 1 via the third rotating shaft 10, and the locking tongue portion 71 and the abutting portion 72 are respectively located on two sides of the third rotating shaft 10.

The third rotating shaft 10 is configured to connect and support the limiting rod and provide a stable rotation center for the limiting rod 7. In some embodiments, the third rotating shaft 10 may be a fixed shaft or pin, and the third rotating shaft 10 is rigidly connected to the carabiner body 1.

In some embodiments of the present disclosure, the limiting rod can rotate more flexibly by connecting to the carabiner body via the third rotating shaft, thereby ensuring smoother locking and unlocking operations.

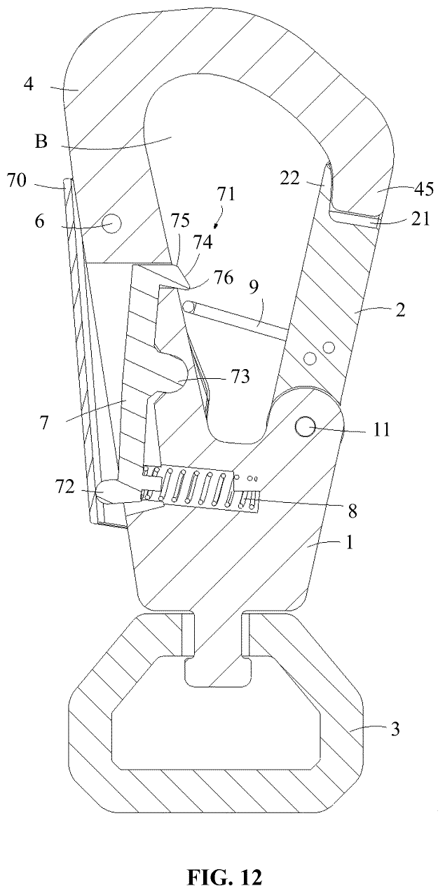

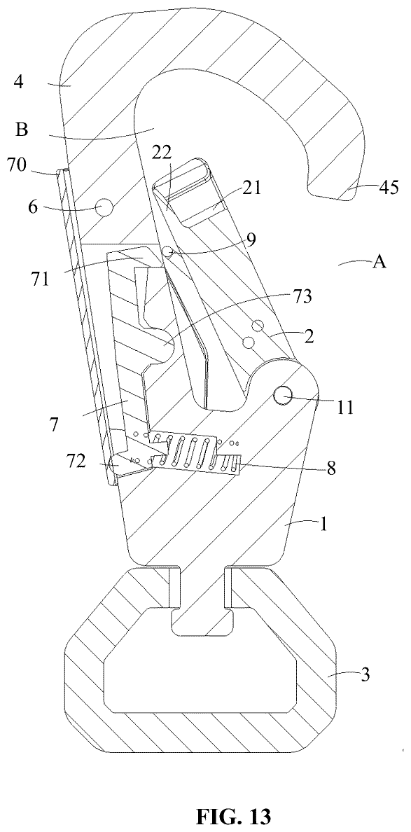

FIG. 12 is a schematic diagram illustrating another cross-sectional view of the self-locking carabiner shown in FIG. 8. FIG. 13 is a schematic diagram illustrating another cross-sectional view of the self-locking carabiner shown in FIG. 9.

In some embodiments, as shown in FIG. 12-FIG. 13, a rotating portion 73 is further disposed on the limiting rod 7, a rotating groove (not shown in the figures) is disposed in the carabiner body 1, the rotating portion 73 rotates along an inner wall of the rotating groove, and the locking tongue portion 71 and the abutting portion 72 are respectively located on two sides of the rotating portion.

The rotating portion 73 refers to a structural member that supports rotation of the limiting rod 7. In some embodiments, the rotating portion 73 may be designed as cylindrical, spherical, or other shapes suitable for rotation. The rotating portion 73 refers to a rotation center of the limiting rod 7, and the limiting rod 7 may perform rotational motion around the rotating portion 73.

The rotating groove refers to a groove body inside the carabiner body 1 for accommodating the rotating portion 73. A shape of the rotating groove matches a shape of the rotating portion 73.

In some embodiments of the present disclosure, the cooperation between the rotating portion 73 and the rotating groove makes the rotation of the limiting rod 7 more stable and precise, thereby preventing the limiting rod 7 from shifting or shaking during movement.

In some embodiments, as shown in FIG. 13, an inclined segment 74 is disposed at an end of the locking tongue portion 71, and a length of a side of the inclined segment 74 away from the buckle body 1 protruding from the inner side wall surface of the hook-shaped arm 4 is less than a length of a side of the inclined segment 74 close to the carabiner body 1 protruding from the inner side wall surface of the hook-shaped arm 4.

The inclined segment 74 refers to an inclined structure disposed at the end of the locking tongue portion 71. A distance by which the inclined segment 74 protrudes from the inner side wall surface of the hook-shaped arm 4 on the side away from the carabiner body 1 is relatively short, thereby facilitating smooth sliding of the locking tongue portion 71 into the hook-shaped arm 4. A distance by which the inclined segment 74 protrudes from the inner side wall surface of the hook-shaped arm 4 on the side close to the carabiner body 1 is relatively long, thereby better blocking movement of the self-locking torsion spring 9 and preventing accidental disengagement.

In some embodiments, an acute angle is formed between the inclined segment 74 and an inner surface of the carabiner body 1 close to the inclined segment 74, thereby preventing the self-locking torsion spring 9 from slipping off.

In some embodiments of the present disclosure, the structural design of the inclined segment 74 can ensure both operational convenience and improve reliability and stability of the self-locking carabiner.

In some embodiments, as shown in FIG. 13, a first arc segment 75 is disposed on the side of the inclined segment 74 away from the carabiner body 1, and a second arc segment 76 is disposed on the side of the inclined segment 74 close to the carabiner body 1.

In some embodiments, the inclined segment 74, the first arc segment 75, and the second arc segment 76 are beneficial for resetting the locking arm. During the reset process of the locking arm 2, the straight segment 91 of the self-locking torsion spring 9 slides from top to bottom along the inner side wall surface of the hook-shaped arm 4, and the inclined segment 74, the first arc segment 75, and the second arc segment 76 can all reduce obstruction of the self-locking torsion spring 9 by the locking tongue portion 71, facilitating the reset of the straight segment 91 of the self-locking torsion spring 9 to a bottom of the locking tongue portion 71.

In some embodiments of the present disclosure, the first arc segment 75 and the second arc segment 76 provide a clear motion trajectory for the locking tongue portion 71, making locking and unlocking operations smoother.

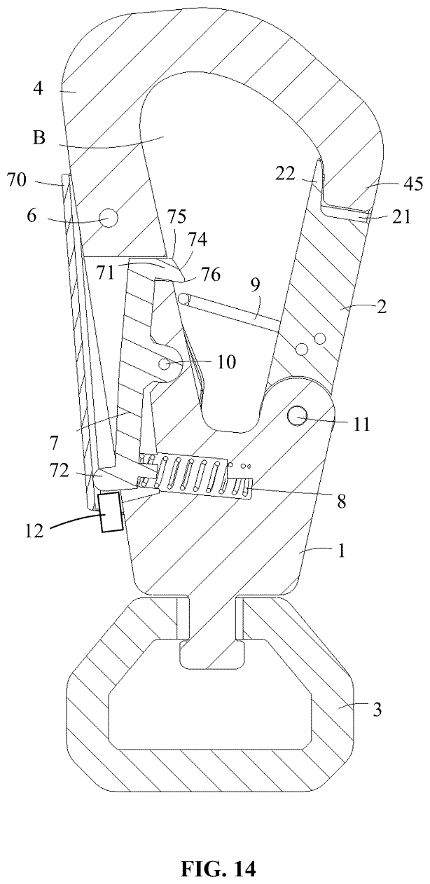

FIG. 14 is a schematic diagram illustrating another installation position of the locking block of the self-locking carabiner according to some embodiments of the present disclosure.

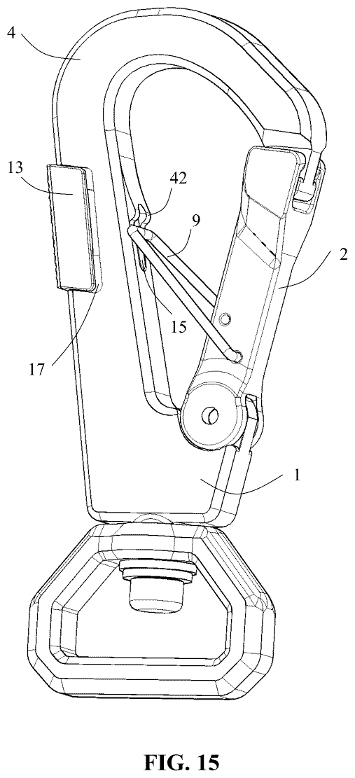

In some embodiments, as shown in FIG. 15, the self-locking carabiner further includes a locking block 12, the locking block 12 is slidably or rotatably disposed on an outer side wall surface of the carabiner body 1, and when the locking arm is in the locked state, the locking block 12 is located between the unlocking member 70 and the carabiner body 1.

In some embodiments, the locking block 12 move away from the unlocking member 70 by sliding or rotating the locking block 12, until there is no longer an obstruction between the unlocking member 70 and the carabiner body 1, and the self-locking carabiner may be unlocked by operating the unlocking member 7 and the locking arm 2.

For more description regarding the locking block 12, please refer to the related description of FIG. 7 above.

In some embodiments of the present disclosure, the locking block 12 is located between the unlocking member 70 and the carabiner body 1, which can effectively prevent accidental movement of the unlocking member 70 and ensure that the locking arm 2 remains in the locked state.

In some embodiments, as shown in FIG. 8, FIG. 10, and FIG. 14, in the normal state, neither the locking arm 2 nor the unlocking member 70 is subjected to an external force. Under the action of the return spring 8, the abutting portion 72 abuts against the unlocking member 70, and the locking tongue portion 71 protrudes from the inner side wall surface of the hook-shaped arm 4. Under the action of the self-locking torsion spring 9, the movable end (an end away from the carabiner body 1) of the locking arm 2 is latched to the open end of the hook-shaped arm 4, the straight segment 91 of the self-locking torsion spring 9 abuts against the locking tongue portion 71, and the straight segment 91 may no longer move, thereby preventing the locking arm 2 from rotating. The rope passing opening A is in the closed state, and the locking arm 2 is in the locked state.

In some embodiments, the pressing force is applied to an end of the unlocking member 70 close to the carabiner body 1, the unlocking member 70 drives the abutting portion 72 to rotate into the carabiner body 1, the abutting portion 72 drives the locking tongue portion 71 to rotate, a front end of the locking tongue portion 71 retracts into the hook-shaped arm 4 and no longer blocks the straight segment 91 of the self-locking torsion spring 9, the return spring 8 is compressed, and the unlocking member 70 is in the unlocked state. As shown in FIG. 9, FIG. 11, and FIG. 13, while maintaining the pressing force on the unlocking member 70, the external force is applied to the locking arm 2 to cause the locking arm 2 to rotate toward the inner side wall surface of the hook-shaped arm 4, the straight segment 91 slides upward (in a direction toward the open end of the hook-shaped arm 4) along the inner side wall surface of the hook-shaped arm 4, the rope passing opening A is gradually opened, and the locking arm 2 is in the unlocked state.

In some embodiments, when the pressing force applied on the locking arm 2 and the external force applied on the unlocking member 4 are released, under the action of the return spring 8, the abutting portion 72 respectively drives the unlocking member 70 and the locking tongue portion 71 to reset, and the locking tongue portion 71 protrudes from the inner side wall surface of the hook-shaped arm 4. Under the action of the self-locking torsion spring 9, the locking arm 2 resets and drives the straight segment 91 to move downward (in a direction toward the carabiner body 1) until the straight segment 91 of the self-locking torsion spring 9 abuts against the locking tongue portion 71, the rope passing opening A is closed, and the locking arm 2 returns to the locked state.

In some embodiments, as shown in FIG. 8-FIG. 14, the guide groove 21 and the limiting portion 22 are respectively disposed on an end of the locking arm 2. The guide fitting portion 45 is disposed on a front end of the hook-shaped arm 4. The guide fitting portion 45 is located in the guide groove 21 and is blocked by the limiting portion 22. For more description regarding the guide groove 21 and the limiting portion 22, refer to FIG. 1-FIG. 7 and the related description.

In some embodiments, the self-locking carabiner further includes an alarm device, the alarm device includes a processor, an alarm, an engagement state sensor, and an inertial sensor. The engagement state sensor is configured to acquire pressure data of contact between the self-locking torsion spring 9 and the carabiner body 1. The inertial sensor is configured to acquire first inertial data of the carabiner body 1 and second inertial data of the unlocking member. The processor is configured to: determine, based on the pressure data, the first inertial data, and the second inertial data, an engagement state of the locking arm through a failure model, and in response to the engagement state being successful engagement, determine a first failure risk; and determine, based on the first failure risk, an alarm parameter of the alarm, and control the alarm to issue an alarm based on the alarm parameter.

The alarm device refers to a system in the self-locking carabiner for issuing alarms.

In some embodiments, the alarm may issue an alarm via sound, light, vibration, etc. In some embodiments, the alarm may include a buzzer, an LED light, a vibrator, etc. For example, the alarm is a buzzer, and under different alarm parameters, a sound volume and a sound pattern of the alarm may be different. In some embodiments, the processor may determine the sound volume and the sound pattern of the alarm by querying a first preset table based on the alarm parameter. The first preset table may preset the volume and the sound pattern of the alarm corresponding to different alarm parameters.

The processor is configured to receive and analyze data from the sensors. In some embodiments, the processor may include, but is not limited to, a central processing unit (CPU), a graphics processing unit (GPU), a field-programmable gate array (FPGA), etc.

The engagement state sensor refers to a sensor for monitoring pressure data of contact between the self-locking torsion spring 9 and the carabiner body 1. In some embodiments, the engagement state sensor may be a piezoelectric sensor array.

The pressure data refers to data reflecting a pressure situation of contact between the self-locking torsion spring 9 and the carabiner body 1. The pressure data may include a pressure magnitude and a pressure distribution.

In some embodiments, as shown in FIG. 1, the engagement state sensor may be disposed on the arc segment 44 of the self-locking carabiner. The engagement state sensor may obtain a pressure when the self-locking torsion spring 9 contacts the arc segment 44.

In some embodiments, as shown in FIG. 9, the engagement state sensor may be disposed on the second arc segment 76 of the self-locking carabiner. The engagement state sensor may obtain a pressure when the self-locking torsion spring 9 contacts the second arc segment 76.

The inertial sensor refers to a sensor configured to monitor a motion state of the carabiner body and the unlocking member. In some embodiments, the inertial sensor may include an accelerometer and a gyroscope. The accelerometer is disposed on the carabiner body 1, and the gyroscope is disposed on the unlocking member 70.

The first inertial data may include an acceleration of the carabiner body 1. In some embodiments, the first inertial data may be obtained by the accelerometer.

The second inertial data may include a three-dimensional posture of the unlocking member 70. The three-dimensional posture may include a direction, an angular velocity, a posture, etc. of the unlocking member 70. In some embodiments, the second inertial data may be obtained by the gyroscope.

The engagement state refers to a connection state between the locking arm 2 and the carabiner body 1 in the self-locking carabiner. In some embodiments, the engagement state may include an engagement success state, an unengaged state, a loose state, etc. The engagement success state may be that a pressure magnitude and a pressure distribution between the locking arm 2 and the carabiner body 1 both satisfy a preset condition. The unengaged state may be that there is no pressure between the locking arm 2 and the carabiner body 1. The loose state may be that there is pressure between the locking arm 2 and the carabiner body 1, but the pressure does not satisfy the preset condition.

In some embodiments, the processor may determine the engagement state of the locking arm 2 by querying a second preset table based on the pressure data, the first inertial data, and the second inertial data. The second preset table may include the engagement state and the pressure data, the first inertial data, and the second inertial data corresponding to the engagement state. A technician may perform experiments on the locking arm 2 with various engagement states, and record the pressure data, the first inertial data, and the second inertial data during the experiments, thereby constructing the second preset table.

The first failure risk refers to a risk of failure of the engagement state of the locking arm 2. In some embodiments, the first failure risk may be represented by a percentage. The self-locking carabiner may have situations such as failure of the self-locking torsion spring 9 or looseness of the unlocking button 5 due to improper use or storage. At this time, even if the engagement state is achieved, factors such as external vibration may cause the locking arm 2 to become unengaged or loose. A greater first failure risk indicates that the engagement state of the locking arm 2 is more likely to become unengaged, leading to greater chances of failure of the engagement state.

In some embodiments, in response to the engagement state being the engagement success state, the processor may determine the first failure risk through the failure model based on the pressure data, the first inertial data, and the second inertial data.

The failure model refers to a model configured to determine the engagement state of the locking arm 2. In some embodiments, the failure model may be a machine learning model. For example, the failure model may include a Recurrent Neural Network (RNN), or another custom model, or a combination of one or more thereof.

In some embodiments, an input of the failure model includes the pressure data, the first inertial data, and the second inertial data, and an output of the failure model includes the first failure risk.

In some embodiments, the failure model may be obtained through training based on training samples with labels. In some embodiments, the training samples may include sample pressure data, sample first inertial data, and sample second inertial data. The labels may be the first failure risk corresponding to the training samples. In some embodiments, the training samples may be obtained based on historical data. The labels may be obtained through manual annotation. For example, if the engagement state fails in the historical data corresponding to the training samples, the labels corresponding to the training samples are annotated as 1; if the engagement state does not fail in the historical data corresponding to the training samples, the labels corresponding to the training sample are annotated as 0.

In some embodiments, the processor may perform training using various manners based on the training samples and the labels. For example, the processor may perform training based on a gradient descent manner. Merely by way of example, the processor may input a plurality of training samples with labels into an initial failure model, construct a loss function based on the labels and results of the initial failure model, and iteratively update parameters of the initial failure model based on the loss function. When the loss function of the initial failure model satisfies a preset condition, model training is completed, and a trained failure model is obtained. The preset condition may be that the loss function converges, an iteration count reaches a threshold, etc.

In some embodiments, the processor may determine the alarm parameter of the alarm by querying a third preset table based on the first failure risk, send the alarm parameter to the alarm, and control the alarm to issue an alarm. The third preset table may preset the first failure risk and an alarm parameter of the alarm corresponding to the first failure risk.

In some embodiments, the input of the failure model further includes a structural feature.

The structural feature may include an engagement structure feature, a structural feature of the unlocking structure (e.g., the unlocking button 5 or the unlocking member 70), and a structural feature of the self-locking torsion spring 9. The engagement structure feature may include a dimension and a disengagement angle of the arc segment 44. The disengagement angle refers to a minimum rotation angle required for the straight segment 91 of the self-locking torsion spring 9 to disengage from the arc segment 44. The structural feature of the unlocking structure may include an elastic coefficient, a thickness, etc. of the unlocking button 5 or the unlocking member 70. The elastic coefficient may include a number of coils and a length of the spring. The structural feature of the self-locking torsion spring 9 may include an elastic coefficient, a number of coils, etc. of the self-locking torsion spring 9.

In some embodiments, the training samples further include a sample structural feature.

In some embodiments of the present disclosure, an attitude of the self-locking carabiner can be determined by the first inertial data and the second inertial data. It can better determine whether locking of the self-locking carabiner is safe and whether there is a failure risk in combination with structural features and the pressure data.

In some embodiments of the present disclosure, a potential failure risk can be discovered in time through the alarm device, thereby avoiding continued use of the self-locking carabiner in an abnormal state and improving safety. The processor runs subsequent determination only when the engagement state is engagement success, thereby saving computing power and thus saving power.

In some embodiments, the self-locking carabiner further includes an elastic force sensor and a torque sensor. The elastic force sensor is configured to obtain elastic force data of the return spring. The torque sensor is configured to obtain torque data of the self-locking torsion spring 9. The processor is further configured to: determine a correction coefficient based on the elastic force data, the torque data, a first elastic coefficient of the return spring, a second elastic coefficient of the self-locking torsion spring 9, and a historical failure risk; and determine a second failure risk based on the correction coefficient and the first failure risk.

The elastic force sensor is configured to measure an elastic force generated by the return spring. For example, the elastic force sensor may be a force sensor or the like. In some embodiments, the elastic force sensor may be disposed at an end of the return spring. When the return spring is compressed or stretched, the elastic force sensor may measure a reaction force generated by the return spring, i.e., the elastic force.

The torque sensor refers to a device configured to measure a torque generated by the self-locking torsion spring 9 in a stressed state. For example, the torque sensor may be a strain gauge type torque sensor, or the like. In some embodiments, the torque sensor may be disposed at a shaft of the self-locking torsion spring 9. When the self-locking torsion spring 9 is twisted, the torque sensor may measure a torsional moment generated by the self-locking torsion spring 9.

The elastic force data refers to a value of an elastic force generated by the return spring when being stressed. In some embodiments, the elastic force data may be obtained through the elastic force sensor.

The torque data refers to a value of a torque generated by the self-locking torsion spring 9 when being subjected to a torsional force. In some embodiments, the torque data may be obtained through the torque sensor.

The first elastic coefficient of the return spring refers to a ratio of an elastic force generated by the return spring when being stressed to its deformation amount. In some embodiments, the first elastic coefficient of the return spring may be obtained through experimental measurement.

The second elastic coefficient of the self-locking torsion spring 9 refers to a ratio of a torque generated by the self-locking torsion spring 9 when being subjected to a torsional force to its torsion angle. In some embodiments, the second elastic coefficient of the self-locking torsion spring 9 may be obtained through experimental measurement.

The historical failure risk refers to an average value or a median value of a plurality of first failure risks and a plurality of second failure risks determined during historical use of the self-locking carabiner. In some embodiments, the historical failure risk may be obtained from historical data.

The correction coefficient refers to a value for correcting the historical failure risk. In some embodiments, a value range of the correction coefficient may be 0.5-1.5. For example, the correction coefficient may be 0.5, and the correction coefficient may also be 1.5.

The second failure risk refers to a risk of failure of the return spring. In some embodiments, the second failure risk may be represented by a percentage, for example, 100% indicates that the return spring completely fails.

In some embodiments, the processor may determine the correction coefficient through weighted summation based on the elastic force data, the torque data, the first elastic coefficient of the return spring, the second elastic coefficient of the self-locking torsion spring 9, and the historical failure risk. The correction coefficient is positively correlated with the elastic force data, the torque data, and the historical failure risk, and is negatively correlated with the first elastic coefficient of the return spring and the second elastic coefficient of the self-locking torsion spring 9. In some embodiments, the processor may determine the correction coefficient by formula (1):

K=k₁*A+k₂*B+k₃*C−k₄*D−k₅*E (1),

where K denotes the correction coefficient, A denotes the historical failure risk, which may take a median value in historical data; B denotes current elastic force data, C denotes current torque data, D denotes the first elastic coefficient of the return spring, E denotes the second elastic coefficient of the self-locking torsion spring 9, k₁-k₅ denote weight conversion coefficients, k₁-k₅ are constants greater than 0, and k₁-k₅ may be set based on experience.

In some embodiments, the processor is further configured to: determine a usage count of the self-locking carabiner based on a historical engagement state; and in response to the usage count exceeding a preset threshold, control the alarm to issue the alarm.

The historical engagement state refers to an engagement state of the self-locking carabiner during historical use. In some embodiments, the historical engagement state may be obtained from historical data.

The usage count refers to a total usage count of the self-locking carabiner during historical use.

In some embodiments, the processor may take a count of engagement success in the historical engagement state as the usage count.

The preset threshold refers to a threshold for determining whether the alarm issues an alarm. In some embodiments, the preset threshold may be set by a technician based on experience.

In some embodiments of the present disclosure, a risk of overuse can be discovered in time by monitoring the usage count of the self-locking carabiner, thereby avoiding functional failure or safety hazards caused by excessive wear.

In some embodiments, the correction coefficient is exponentially correlated with the usage count.

In some embodiments, the processor may determine the weight conversion coefficients k₂ and k₃ by looking up a fourth preset table based on the usage count. The fourth preset table includes a mapping relationship between the usage count and the weight conversion coefficients k₂ and k₃. The fourth preset table may be set based on requirements or experience.

In some embodiments, the weight conversion coefficient k₂ of the elastic force data and the weight conversion coefficient k₃ of the torque data are positively correlated with the usage count. For example, when the usage count increases, k₂ and k₃ increase exponentially, thereby causing the correction coefficient to increase exponentially. When the usage count increases, even if the elastic force data and the torque data in the engagement state are small, the final correction coefficient is still large.

In some embodiments, after the weight conversion coefficient k₁ of the historical failure risk, the weight conversion coefficient k₄ of the first elastic coefficient, and the weight conversion coefficient k₅ of the second elastic coefficient are determined to constants, there are no adjustment.

In some embodiments, when the usage count increases to a certain extent, the failure risk increases significantly. The exponential correlation between the correction coefficient and the usage count ensures that the final correction coefficient is large, which is beneficial for risk control.

In some embodiments of the present disclosure, the remaining life of the self-locking carabiner can be predicted more accurately through the exponential relationship between the correction coefficient and the usage count.

In some embodiments, the processor may use the product of the correction coefficient and the first failure risk as the second failure risk. If the product of the correction coefficient and the first failure risk is greater than 100%, the processor may mark the second failure risk as 100%.

In some embodiments of the present disclosure, an elastic force change of the return spring is monitored in real time through the elastic force sensor to accurately grasp the locked state and force condition of the self-locking carabiner. A torque change of the self-locking torsion spring 9 is monitored in real time through the torque sensor to further evaluate the locking stability and force distribution of the self-locking carabiner, so that comprehensive monitoring of the force state of the self-locking carabiner is achieved to detect abnormal situations in a time and improve the safety and reliability of the self-locking carabiner. The force state of the self-locking carabiner is dynamically adjusted based on the elastic coefficients of the return spring and the self-locking torsion spring 9, combined with the elastic force data and the torque data. The failure risk of the self-locking carabiner is evaluated through historical data and real-time monitoring results, and the correction coefficient is determined, so that the safety of the self-locking carabiner is further optimized, thereby effectively reducing the risk of failure of the self-locking carabiner, and ensuring that the self-locking carabiner can still maintain stable operation under extreme conditions.

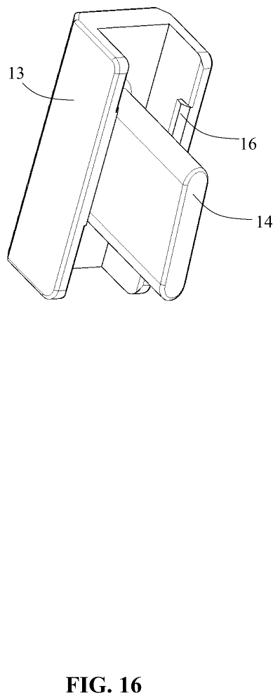

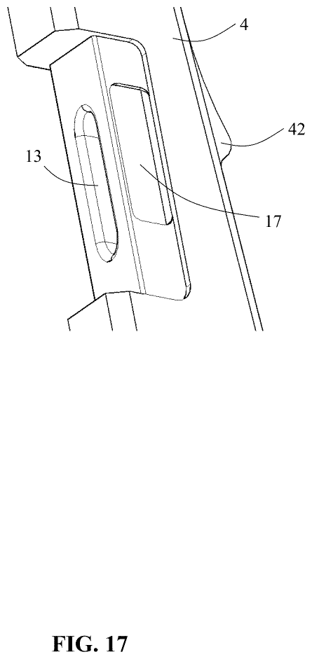

FIG. 15 is a schematic diagram illustrating a three-dimensional structure of the self-locking carabiner according to some embodiments of the present disclosure. FIG. 16 is a schematic diagram illustrating a three-dimensional structure of a movable button and a pushing part according to some embodiments of the present disclosure. FIG. 17 is a schematic diagram illustrating an enlarged structure of a hook-shaped arm at a through hole according to some embodiments of the present disclosure.

In some embodiments, as shown in FIG. 15-FIG. 17, the unlocking structure includes a movable button 13 and a pushing part 14, the movable button 13 is arranged on an outer side wall surface of the hook-shaped arm 4, a through hole 41 is provided on the hook-shaped arm 4, the pushing part 14 is slidably clamped in the through hole 41, and a pushing surface 15 is provided on the pushing part 14. A protrusion 42 is provided on an inner side wall surface of the hook-shaped arm 4, one end of the self-locking torsion spring 9 is disposed on the locking arm 2, and when the locking arm 2 is in the locked state, the other end of the self-locking torsion spring 9 abuts against the protrusion 42 to prevent the locking arm 2 from rotating. The pushing surface 15 protrudes out of the through hole 41 by applying a pressing force to the movable button 13, to lift an end of the self-locking torsion spring 9 that abuts against the protrusion 42 to separate from the protrusion 42, and the locking arm 2 switches from the locked state to the unlocked state.

For more content regarding the hook-shaped arm 4, the through hole 41, the self-locking torsion spring 9, the locking arm 2, and the protrusion 42, refer to FIG. 1-FIG. 14 and the related descriptions.

The movable button 13 is configured to receive the external pressure and drive the pushing part 14 to move. In some embodiments, the movable button 13 is located on the outer side wall surface of the hook-shaped arm 4 away from the locking arm 2. A size of the movable button 13 is larger than a size of the through hole 41, thereby preventing the movable button 13 from entering the through hole 41. In some embodiments, the movable button 13 may be a structure covering the outer side wall surface of the hook-shaped arm 4.

The pushing part 14 is configured to transmit the pressing force of the movable button 13 and push the locking arm 2 to rotate. In some embodiments, a shape and a size of the pushing part 14 match a shape and a size of the through hole 41, so that the pushing part 14 is slidably clamped in the through hole 41. For example, a cross-section of the pushing part 14 perpendicular to a penetration direction of the through hole 41 may be circular, elliptical, or square.

In some embodiments, the size of the pushing part 14 is slightly larger than the size of the through hole 41, so that the pushing part 14 may be clamped in the through hole 41. The pushing part 14 may slide within the through hole 41 by applying a certain external force.

The movable button 13 and the pushing part 14 may be connected in a plurality of ways. For example, the movable button 13 and the pushing part 14 are integrally formed. As another example, the movable button 13 and the pushing part 14 are detachably connected by a snap-fit, a screw, etc.

The pushing surface 15 refers to a surface of the pushing part 14 close to the self-locking torsion spring 9. In some embodiments, the pushing surface 15 is the portion of the pushing part 14 that directly contacts the self-locking torsion spring 9, and the shape of the pushing surface 15 may be designed as a plane or an arc surface to optimize contact with the torsion spring and force transmission.

In the locked state, the self-locking torsion spring 9 contacts the pushing surface 15 and abuts against the protrusion 42, the pushing surface 15 does not protrude from the through hole 41. When the self-locking torsion spring moves along the pushing surface 15 in a direction away from the carabiner body 1, the movable end of the self-locking torsion spring 9 abuts against the stopping position of the protrusion 42, thereby preventing the locking arm 2 from continuing to rotate. When switching from the unlocked state to the locked state, the pressing force is applied to the movable button 13 to drive the pushing part 14 to slide along the through hole 41 toward the inner side wall surface of the hook-shaped arm 4, and the pushing surface 15 protrudes out of the through hole 41 to push the self-locking torsion spring 9 to be lifted so that the self-locking torsion spring 9 no longer abuts against the protrusion 42. The external force is applied to the locking arm 2 to cause the locking arm 2 to rotate toward the inner side wall surface of the hook-shaped arm 4, the self-locking torsion spring 9 may move along the pushing surface 15 to pass over the protrusion 42 and slide along the inner side wall surface of the hook-shaped arm 4 in the direction away from the carabiner body 1.

In some embodiments of the present disclosure, the user can easily switch the self-locking carabiner from the locked state to the unlocked state by pressing the movable button 13, and the operation is simple and intuitive. The cooperation between the movable button 13 and the pushing part 14 can avoid jamming and hysteresis during unlocking, significantly improving the smoothness and response speed of unlocking. Simultaneously, direct force transmission is achieved and the structure is more compact, so that the operational convenience and the system stability are improved to extend the service life of the device.

In some embodiments, as shown in FIG. 16-FIG. 17, a guide member 16 is disposed on the hook-shaped arm 4, a guide matching member 17 is arranged on the movable button 13, and the guide member 16 and the guide matching member 17 are slidably connected.

The guide member 16 is configured to guide the moving direction of the movable button 13. The guide matching member 17 is configured to cooperate with the guide member 16 to achieve the guiding function.

In some embodiments, as shown in FIG. 16-FIG. 17, the guide member 16 is a groove (e.g., a sliding groove) provided on the outer side wall surface of the hook-shaped arm 4, and the guide matching member 17 is a protruding structure (e.g., a sliding block, a sliding bar) on the inner side of the movable button 13. When a pressing force is applied to the movable button 13, the sliding block or the sliding bar may slide within the sliding groove in a direction toward the self-locking torsion spring 9.

In some embodiments, the guide member 16 is a protruding structure (e.g., a sliding block, a sliding bar) on the outer side wall surface of the hook-shaped arm 4, and the guide matching member 17 is a groove (e.g., a sliding groove) provided on the inner side of the movable button 13. Merely by way of example, when the pressing force is applied to the movable button 13, the sliding groove may slide along the sliding block or the sliding bar in a direction toward the self-locking torsion spring 9.

In some embodiments, the guide member 16 and the guide matching member 17 are in an interference fit, the guide member 16 and the guide matching member 17 may slide relative to each other by applying the pressing force to the movable button 13. When no pressing force is applied, the guide member 16 and the guide matching member 17 are in a tight fit, thereby fixing the movable button 13 on the outer side wall surface of the hook-shaped arm 4.

In some embodiments of the present disclosure, the moving direction of the movable button 13 can be guided by providing the guide member 16 and the guide matching member 17, thereby effectively achieving stable and smooth movement of the movable button 13 and improving operational reliability and user experience.

The basic concepts have been described above. Obviously, to those skilled in the art, the above detailed disclosure is merely an example and does not constitute a limitation on the present disclosure. Although not explicitly stated herein, those skilled in the art may make various modifications, improvements, and corrections to the present disclosure. Such modifications, improvements, and corrections are suggested in the present disclosure, so such modifications, improvements, and corrections still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean a certain feature, structure, or characteristic related to at least one embodiment of the present disclosure. Therefore, it should be emphasized and noted that the references to “an embodiment” or “one embodiment” or “an alternative embodiment” two or more times in different locations in the present disclosure do not necessarily refer to the same embodiment. In addition, certain features, structures, or characteristics in one or more embodiments of the present disclosure may be appropriately combined.

Similarly, it should be noted that in order to simplify the expression disclosed in the present disclosure and thereby help the understanding of one or more inventive embodiments, sometimes multiple features are grouped into one embodiment, drawing, or description thereof in the foregoing description of the embodiments of the present disclosure. Rather, claimed subject matter may lie in less than all features of a single foregoing disclosed embodiment.

In some embodiments, numbers describing the quantity of components and attributes are used. It should be understood that such numbers used in the description of the embodiments are modified by the modifiers “about,” “approximately,” or “substantially” in some examples. Unless otherwise stated, “about,” “approximately,” or “substantially” indicates that the stated number allows a variation of ±20%. Accordingly, in some embodiments, the numerical parameters used in the present disclosure are all approximate values, and these approximate values may vary according to the required characteristics of individual embodiments. In some embodiments, the numerical parameters should consider the specified significant digits and adopt the method of general digit retention. Although the numerical ranges and parameters used in some embodiments of the present disclosure to confirm the breadth of the scope are approximate values, in specific embodiments, the setting of such numerical values is as precise as possible within the feasible range.

Finally, it should be understood that the embodiments described in the present disclosure are only used to illustrate the principles of the embodiments of the present disclosure. Other modifications may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A self-locking carabiner, comprising: a carabiner body, a locking arm, and a carabiner ring, wherein
the carabiner ring is disposed at one end of the carabiner body, a hook-shaped arm is disposed at the other end of the carabiner body, a rope passing opening is formed between an end of the hook-shaped arm away from the carabiner body and the carabiner body, an end of the locking arm close to the carabiner body is rotatably connected to the carabiner body, and an end of the locking arm away from the carabiner body is latched to an end of the hook-shaped arm close to the carabiner body; and
an unlocking structure is disposed on the hook-shaped arm, the unlocking structure is movably connected to the hook-shaped arm, the locking arm includes a locked state and an unlocked state, and the locked state and the unlocked state are controlled by the unlocking structure.

2. The self-locking carabiner according to claim 1, wherein the unlocking structure comprises an unlocking button, a through hole is disposed on the hook-shaped arm, the unlocking button is movably engaged in the through hole, the unlocking button comprises a button portion and a pushing portion, the button portion and the pushing portion are respectively located on opposite sides of the unlocking button, and a sliding surface is disposed on the pushing portion;
a protrusion is disposed on an inner side wall surface of the hook-shaped arm, and one end of a self-locking torsion spring is disposed on the locking arm,
when the locking arm is in the locked state, the other end of the self-locking torsion spring abuts against the protrusion to prevent the locking arm from rotating; and
when the sliding surface is pushed into the through hole of the hook-shaped arm, an end of the sliding surface away from the carabiner body protrudes from the through hole by applying a pressing force to an end of the button portion away from the carabiner body, to lift an end of the self-locking torsion spring that abuts against the protrusion to separate from the protrusion, and the locking arm switches from the locked state to the unlocked state.

3. The self-locking carabiner according to claim 2, wherein the unlocking button further comprises an elastic portion and an engaging portion, the elastic portion is disposed at an end of the unlocking button away from the carabiner body, the engaging portion is disposed at an end of the unlocking button close to the carabiner body, and the elastic portion is connected to the pushing portion.

4. The self-locking carabiner according to claim 2, wherein an arc-shaped inclined surface is disposed on the protrusion, and the arc-shaped inclined surface curves and transitions along the inner side wall surface of the hook-shaped arm in a direction away from the carabiner body.

5. The self-locking carabiner according to claim 2, wherein an arc segment is disposed at a top end of the protrusion, and the arc segment is connected to the arc-shaped inclined surface.

6. The self-locking carabiner according to claim 2, wherein a straight segment is disposed at an end of the self-locking torsion spring close to the protrusion, and when the locking arm is in the locked state, the straight segment abuts against the protrusion to prevent the locking arm from rotating.

7. The self-locking carabiner according to claim 1, wherein a first rotating shaft is further disposed on the carabiner body, and the end of the locking arm close to the carabiner body is rotatably connected to the carabiner body via the first rotating shaft.

8. The self-locking carabiner according to claim 1, wherein a guide groove and a limiting portion are respectively disposed at the end of the locking arm away from the carabiner body, a guide fitting portion is disposed at the end of the hook-shaped arm close to the carabiner body, the guide groove and the guide fitting portion are matched, and when the locking arm is in the locked state, the guide fitting portion is located in the guide groove and is blocked by the limiting portion.

9. The self-locking carabiner according to claim 2, wherein the self-locking carabiner further comprises a locking block, the locking block is slidably or rotatably disposed on an outer side wall surface of the hook-shaped arm, and when the locking arm is in the locked state, the locking block is located between the button portion of the unlocking button and the hook-shaped arm.

10. The self-locking carabiner according to claim 2, wherein the unlocking button further comprises a groove, a first boss, and a second boss, and each of the first boss and the second boss comprises an inner convex arc segment.

11. The self-locking carabiner according to claim 1, wherein the unlocking structure comprises an unlocking member, a limiting rod, and a return spring;
the unlocking member is disposed outside the hook-shaped arm, the unlocking member is rotatably connected to the hook-shaped arm via a second rotating shaft, the limiting rod and the return spring are disposed in the carabiner body, and the limiting rod is rotatably connected to the carabiner body; and
a locking tongue portion and an abutting portion are respectively disposed at two ends of the limiting rod, when the locking arm is in the locked state, the locking tongue portion at least partially protrudes from an inner side wall surface of the hook-shaped arm, the abutting portion abuts against the unlocking member, one end of a self-locking torsion spring is disposed on the locking arm, and the other end of the self-locking torsion spring abuts against the locking tongue portion to prevent the locking arm from rotating.

12. The self-locking carabiner according to claim 11, wherein a straight segment is disposed at an end of the self-locking torsion spring close to the locking tongue portion, and when the locking arm is in the locked state, the straight segment abuts against the locking tongue portion to prevent the locking arm from rotating.

13. The self-locking carabiner according to claim 11, wherein a third rotating shaft is further disposed on the carabiner body, the limiting rod is rotatably connected to the carabiner body via the third rotating shaft, and the locking tongue portion and the abutting portion are respectively located on two sides of the second rotating shaft.

14. The self-locking carabiner according to claim 11, wherein a rotating portion is further disposed on the limiting rod, a rotating groove is disposed in the carabiner body, the rotating portion rotates along an inner wall of the rotating groove, and the locking tongue portion and the abutting portion are respectively located on two sides of the rotating portion.

15. The self-locking carabiner according to claim 11, wherein an inclined segment is disposed at an end of the locking tongue portion, and a length of a side of the inclined segment away from the carabiner body protruding from the inner side wall surface of the hook-shaped arm is less than a length of a side of the inclined segment close to the carabiner body protruding from the inner side wall surface of the hook-shaped arm.

16. The self-locking carabiner according to claim 15, wherein a first arc segment is disposed on the side of the inclined segment away from the carabiner body, and a second arc segment is disposed on the side of the inclined segment close to the carabiner body.

17. The self-locking carabiner according to claim 11, wherein the self-locking carabiner further comprises a locking block, the locking block is slidably or rotatably disposed on an outer side wall surface of the carabiner body, and when the locking arm is in the locked state, the locking block is located between the unlocking member and the carabiner body.

18. The self-locking carabiner according to claim 11, wherein the self-locking carabiner further comprises an alarm device, wherein the alarm device comprises a processor, an alarm, an engagement state sensor, and an inertial sensor; wherein
the engagement state sensor is configured to acquire pressure data of contact between the self-locking torsion spring and the carabiner body;
the inertial sensor is configured to acquire first inertial data of the carabiner body and second inertial data of the unlocking member; and
the processor is configured to:
determine, based on the pressure data, the first inertial data, and the second inertial data, an engagement state of the locking arm through a failure model, and in response to the engagement state being successful engagement, determine a first failure risk; and
determine, based on the first failure risk, an alarm parameter of the alarm, and control the alarm to issue an alarm based on the alarm parameter.

19. The self-locking carabiner according to claim 1, wherein the unlocking structure comprises a movable button and a pushing part, wherein the movable button is arranged on an outer side wall surface of the hook-shaped arm, a through hole is provided on the hook-shaped arm, the pushing part is slidably clamped in the through hole, and a pushing surface is provided on the pushing part;
a protrusion is disposed on an inner side wall surface of the hook-shaped arm, and one end of a self-locking torsion spring is disposed on the locking arm;
when the locking arm is in the locked state, the other end of the self-locking torsion spring abuts against the protrusion to prevent the locking arm from rotating; and
the pushing surface protrudes out of the through hole by applying a pressing force to the movable button, to lift an end of the self-locking torsion spring that abuts against the protrusion to separate from the protrusion, and the locking arm switches from the locked state to the unlocked state.

20. The self-locking carabiner according to claim 19, wherein a guide member is disposed on the hook-shaped arm, a guide matching member is arranged on the movable button, and the guide member and the guide matching member are slidably connected.
